(19) United States
(12) Patent Application Publication
(10) Pub. No.: US 2025/0254567 A1
(43) Pub. Date: Aug. 7, 2025

(54) ENHANCED MEASUREMENT REPORTING FOR USER EQUIPMENT

(71) Applicant: Nokia Technologies Oy, Espoo (FI)

(72) Inventors: Knud KNUDSEN, Aalborg (DK); Samantha CAPORAL DEL BARRIO, Aalborg (DK); Kim NIELSEN, Aalborg (DK); Faranaz SABOURI-SICHANI, Aalborg (DK); Benny VEJLGAARD, Aalborg (DK); Simon SVENDSEN, Aalborg (DK)

(21) Appl. No.: 18/855,027

(22) PCT Filed: Mar. 17, 2023
(86) PCT No.: PCT/FI2023/050155

§ 371 Date: Oct. 8, 2024

Related U.S. Application Data
(60) Provisional application No. 63/335,799, filed on Apr. 28, 2022.

(51) Int. Cl. H04W 28/08; H04W 24/08

(52) U.S. Cl. CPC H04W 28/0967; H04W 24/08

(57) ABSTRACT

According to an aspect, there is provided a terminal device comprising means for measuring signal quality (300) of a non-serving cell (232); determining based on said signal quality a beam (310) for said non-serving cell; determining, for the non-serving cell, a first antenna gain (320) obtainable with said beam if the non-serving cell is added as a secondary cell in multicarrier connectivity with a serving cell; transmitting to a base station of the serving cell information on said determined first antenna gain (330).

### TECHNOLOGICAL FIELD

Embodiments of the present disclosure relate to beam configuration. Some relate to correcting for the effects of changes in beam configuration.

### BACKGROUND

A node of a radio telecommunications network, such as a radio terminal or base station, can use a variable antenna configuration for communication in the radio telecommunication network. In some examples, a node can select between spatially di-verse antenna panels or antennas. In some examples to perform beamforming, a node can selectively use or controllably use different antenna elements within an antenna array of an antenna panel, for example use different weights for the antenna elements. In some examples, the antenna configuration at a radio terminal can be controlled, at least partially, by the radio terminal.

### BRIEF SUMMARY

According to an aspect, there is provided the subject matter of the independent claims. Embodiments are defined in the dependent claims. The scope of protection sought for various embodiments is set out by the independent claims.

The embodiments and features, if any, described in this specification that do not fall under the scope of the independent claims may be interpreted as examples useful for understanding various embodiments.

### BRIEF DESCRIPTION OF THE DRAWINGS

In the following, some embodiments will be described with reference to the accompanying drawings, in which

FIG. 1 shows an example of the subject matter described herein;

FIG. 2 shows an example of the subject matter described herein;

FIG. 3 shows an example of the subject matter described herein;

FIG. 4 shows an example of the subject matter described herein;

FIG. 5 shows an example of the subject matter described herein;

FIG. 6 shows an example of the subject matter described herein;

FIG. 7 shows an example of the subject matter described herein;

FIG. 8 shows an example of the subject matter described herein;

### DETAILED DESCRIPTION

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In the following, different exemplifying embodiments will be described using, as an example of an access architecture to which the embodiments may be applied, a radio access architecture based on long term evolution advanced (LTE Advanced, LTE-A) or new radio (NR, 5G), or 6G, without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

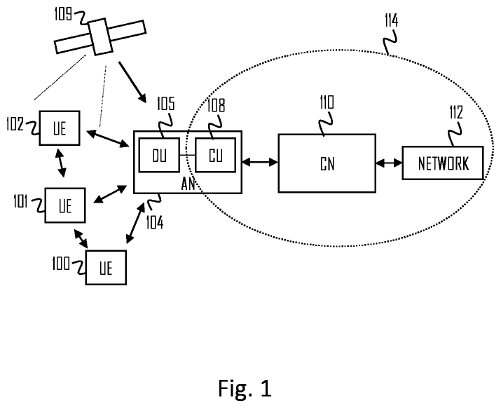

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 100, 101, and 102 configured to be in a wireless connection on one or more communication channels in a cell with an access node (such as (e/g) NodeB) 104 providing the cell. (e/g) NodeB refers to an eNodeB or a gNodeB, as defined in 3GPP specifications. The physical link from a user device to a (e/g) NodeB is called uplink or reverse link and the physical link from the (e/g) NodeB to the user device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used not only for signalling purposes but also for routing data from one (e/g) NodeB to another. The (e/g) NodeB is a computing device configured to control the radio resources of communication system it is coupled to. The NodeB may also be referred to as a base station, an access point, an access node, or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to user devices. The antenna unit may comprise a plurality of antennas or antenna elements. The (e/g) NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 109 in the megaconstellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) nodeBs), a home node B gateway, or HNB-GW (not shown in FIG. 1). A HNB Gateway (HNB-GW), which is typically installed within an operator's network may aggregate traffic from a large number of HNBs back to a core network.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

Mobile Communications at mmW frequencies (e.g. FR2 around 28 GHz & 39 GHz and beyond 52.6 GHz) suffers from high pathloss, e.g. 100 dB for 100 meters at 28 GHz (when calculated for wave length sized unit antennas). In addition, power amplifiers with decent transmit power at mmW are more challenging than for FR1 operation, and larger bandwidths are used in FR2 and beyond, both of which decrease the power spectral density. These effects massively threaten the link budget (i.e. decreases the UE range/cell size).

In NR, the higher pathloss is mitigated by beamforming at the base station (gNB), but also at the UE side in FR2, where panels are used to achieve beamforming gain, which compensates for the link budget loss. Unfortunately, high beamforming gain also implies a high spatial filtering, i.e. the higher the beamforming gain the tighter/narrower are the beams. Each panel on the UE can exhibit different antenna gain and radiation beam widths. For example, different antenna array configurations may cause one patch of the antenna panel being active to exhibit a 90-degree Half-Power Beam Width (HPBW), or two patches being active to exhibit a 45-degrees HPBW or four patches being active to exhibit a 22 degree HPBW. These are only a few non-limiting examples.

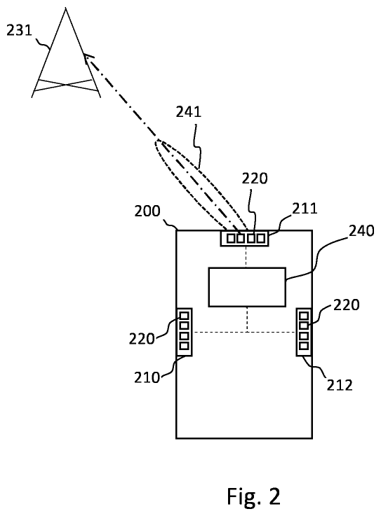

FIG. 2 illustrates the operation of cell in a radio communication network, where the terminal device or a User Equipment (UE) 200 communicates with the radio communication network. UE 200 comprises at least one antenna panel 220 and a communication circuitry 240 that is configured to communicate in the radio telecommunications network via one or more of the at least one antenna panel 210, 211,212. Each antenna panel 210, 211, 212 may comprise a plurality of antenna elements 220. In this example, UE 200 is communicating with the cell 231 via antenna panel 211 using beam 241 towards cell 231.

The beam 241 may be characterized as a narrow beam, compared to a wide beam. A wide beam can for instance be achieved by using a single antenna element in the array and the narrow beam can be achieved by using for example all elements of the antenna array, to achieve beamforming. In practice there may be more beam widths to choose among depending on the size of the antenna array and the number of active antenna elements. Furthermore, whether the UE covers single or multiple Transmission/Reception Points (TRPs) with the narrow beam chosen may also depend on UE orientation since linear arrays have different spatial filtering in azimuth and elevation planes, making the UE decision not straightforward.

In 3GPP, the UE beam configuration choice is left up to UE implementation. Typically, the UE requires network assistance to align and track its narrow beam. UE beam management can be performed in three phases, Phase #1, Phase #2 and Phase #3. In phase #1 (P1), UE uses a broad Rx beam while gNB is performing SS burst where SSBs are swept and transmitted in different directions covering the cell. UE measures RSRP for all SSB beams on all UE panels and sends PRACH on the RACH Occasion of the best SSB beam to connect to the network with the reciprocal transmit (Tx) beam of the best SSB beam. In phase #2 (P2), UE uses a broad Rx beam to receive gNB refined DL CSI-RS beam sweeping within the connected SSB beam. UE measures RSRP for all CSI-RS beams and reports best beam ID(s) back to gNB still using the reciprocal broad Tx beam. In phase #3 (P3), gNB transmits a repeated CSI-reference signal with the selected beam based on UE reporting in Phase #2 and UE sweeps refined Rx beam settings to identify its best narrow Rx beam. As outcome of the UE beam management, alignment between gNB Tx beam and UE Rx beam is obtained for maximized directional gain.

UE panel and beam decision for reporting of DL reference signal in intra-cell and inter-cell beam management would not be an issue for the network if the UE configures its panels with the same beam gain. However, this might not always be possible e.g. in case the UE is equipped with panels of different size, e.g. two 1×4 arrays and 1×8 array on the same UE. For example, when there is a need by the UE to simultaneously serve multiple TRPs or gNBs, additional challenges to mobility procedures may emerge, as panel capabilities on the UE may not be known by the network. Thus, UE orientation and antenna beam pattern properties in relation to UE antenna panel operation are of importance. Regardless, current activity in 3GPP is related to support for downlink carrier aggregation with focus on the architecture in which the UE may support multi-carrier connectivity (e.g. single-chain or multi-chain architecture) with beam management on more than one panel, or limited to beam management of a single carrier, without consideration of UE antenna pattern.

During neighbour cell measurements the UE typically uses a broad beam (i.e. single patch active on the antenna array) in order to detect as many cells as possible. Then, when the UE reports a measurement of a neighbour cell, the gNB is unaware of the potential increased gain towards the target, as this depends on the array size used to attach to the target and it is not communicated to the gNB. In order to inform this to the gNB, the UE may report an indication of array configuration correction index (ACCI) to the gNB. ACCI may reflect the potential beam gain that may be provided after UE Rx beam refinement (e.g. after phase #3 procedure). In other words, it may be seen as an indication describing predictable maximum directivity a given antenna panel could achieve (i.e. maximum gain potential) based on the panel configuration (e.g. beam) that was used to perform the associated RSRP measurement. For example, it can be assumed that a gain of e.g. 3 dB is obtained for every doubling of the number of patches it applies. The step size 3 dB is merely a non-limiting example and other values may be selected based on testing or simulations.

The use cases of carrier aggregation and dual-connectivity are special cases since the UE needs to simultaneously serve two or more TRPs. However, in case the UE needs to communicate with two or more gNBs simultaneously (e.g. carrier aggregation, dual connectivity or multi-TRP) from the same array, the UE may either use the same narrow beam as for PCell (if PCell and SCell are collocated), or decide to use a broader beam to increase its spherical coverage and cover all signal sources (e.g. gNBs, TRPs) with one beam. In the latter case, the reported ACCI may no longer be valid. This restriction of one wide beam instead of two narrow beams per antenna panel may be due to the UE RF architecture limitation that only utilizes single-chain in the RF front-end (i.e. 1 set of phase shifters) per panel, therefore the UE can only use one beam per panel at a time.

One problem of the current procedure is that the above discussed ACCI value reported may not reflect the achievable RSRP in the case that multiple links are active simultaneously in non-collocated scenarios, where UE shares a common UE beam (Rx spatial filter) to receive both TRPs simultaneously. According to various, but not necessarily all, embodiments there is provided an apparatus (e.g. terminal device) comprising means for measuring the signal quality of a non-serving cell in a radio communication network; determining based on said signal quality a beam for the non-serving cell; determining, for the non-serving cell, a first antenna gain obtainable with said beam if the nonserving cell is added as a secondary cell in multi-carrier connectivity with a serving cell; and transmitting to a base station of the serving cell information on said determined first antenna gain.

In some but not necessarily all examples, an extra information is added to the Radio Resource Management (RRM) measurements and Reference Signal Received Power (RSRP) values reported to the network in connected mode, specifically related to the (optional) extra antenna gain (e.g. the first antenna gain) which can be achieved by the User Equipment (UE) for neighbour cell reception if the neighbor (currently nonserving) cell is added simultaneously along with the current connected cell (i.e. not replacing the current serving cell). Based on this information, the network may use the RRM measurement results from the user equipment to evaluate if a neighbour cell can/should replace the serving cell (handover) or if the neighbour cell may/should be used in parallel to the serving cell, e.g. for adding a secondary cell (SCell) in carrier aggregation (CA) deployment or a primary secondary cell (PSCell) in dual connectivity (DC) deployment. The UE may report the achievable antenna gain towards each TRP, thereby allowing the network to adjust the secondary cell selection mechanism depending on the achievable UE antenna gain for simultaneous operation. In an embodiment, this information may be complementary to the ACCI value discussed above. Term “multi-carrier connectivity comprises either carrier aggregation (CA) or multi-connectivity, such as dual connectivity (DC), or both.

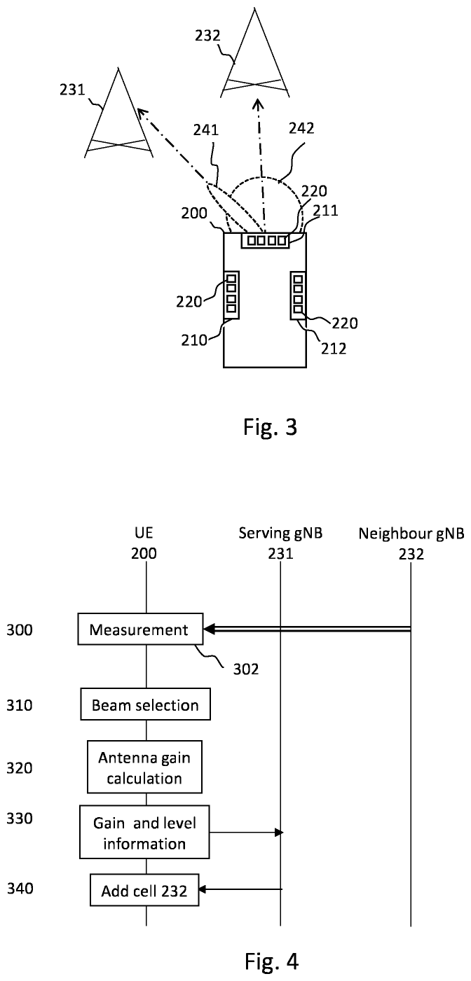

FIG. 3 illustrates an example where UE 200 is served by cell 231 using antenna panel 211 and beam 241 of the UE 200. In this example UE 200 measures a neighbour cell 232 with measurement 302 (see FIG. 4). In the example, measurement 302 is done using at least the antenna panel 211, but possibly with other antenna panels too. If the measurement 302 indicates that antenna gain (e.g. second antenna gain, described later in more details) for serving cell 231 would not decrease below a defined threshold, when both cell 231 and 232 would be used for simultaneous communication, the network may decide to add cell 232 for the user equipment in multi-carrier connectivity. If cell 232 is added along with the serving cell 231 in the multi-carrier connectivity, the two cells 231,232 would in this example share the same antenna panel 211 possibly due to the angular similarity of the first and the second cells 231, 232. Hence, potentially a wide beam 242 is used for such simultaneous operation. The base station may inform UE 200 to add cell 232 as secondary cell.

FIG. 4 illustrates the message sequence procedure in this example.
At stage 300, UE 200 measures the signal quality of at least one neighbouring cell with at least one antenna panel, in this example, cell 232 with measurement 302.
At stage 310, UE 200 selects an antenna panel, among the at least one antenna panel, and a beam of this selected antenna panel that can be used for communication with neighbouring cell 232. The selection of antenna panel and beam of the antenna panel to communicate with the cell 232 may be based on the signal quality measurements performed with one or more antenna panels at stage 300. E.g. the antenna panel that provides the best signal quality, such as RSRP, may be used for the communication. It may occur that the antenna panel selected is the one that is already used for communication with the serving cell. In such case, the beam to be used may be a wide beam 242 from antenna panel 211, instead of a narrow beam, for the cell 232. This may be because each antenna panel may be capable of operating with only one beam at a time. In case the antenna panel is a different antenna panel than the one use for communication with the current serving cell, a narrow beam may be formed towards the cell 232.
At stage 320, UE 200 determines antenna gain 320, e.g. the first antenna gain for the cell 232, in case the non-serving cell 232 is added in multicarrier connectivity with the current serving cell 231. In this example case of FIG. 3, this would mean that the beam of antenna panel 211 is used for communication simultaneously on the serving cell 231 and on the non-serving cell 232. In an embodiment, this may comprise determining also the second antenna gain for the serving cell if the beam of antenna panel 211 is used for communication simultaneously on the serving cell 231 and on the non-serving cell 232. For example, it may be that the beam that is used for the serving cell 231 currently is a narrow beam providing good antenna gain, and that would need to be changed to a wide beam which does not provide as good antenna gain as the narrow beam.
At stage 330, UE 200 transmits serving cell 231 information 330 on the obtainable gain(s) if non-serving cell 232 is added as a secondary cell (Scell or PSCell) in multicarrier connectivity. The information 330 may be reporting as SCell value, which may quantize the obtainable gain in a number of steps, as shown in Table 1.
At stage 340, the serving cell 231 tells UE 200 to add cell 232 in multicarrier connectivity.

TABLE 1
Example of quantization of antenna gain in steps.

| Total # of Elements/ | | gNB infers potential |
|---|---|---|
| # of active | Reported | gain factor |
| antenna elements UE | value | on reported link |
| 8 | 3 | 9 dB |
| 4 | 2 | 6 dB |
| 2 | 1 | 3 dB |
| 1 | 0 | 0 dB |

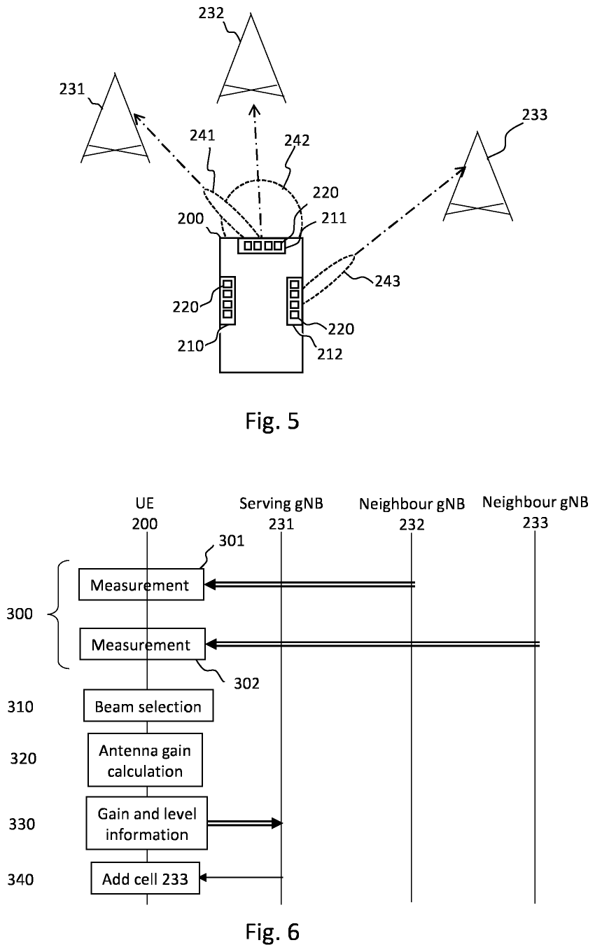

In FIG. 5, the UE 200 is served by cell 231 using antenna panel 211 using beam 241 of UE 200. In this example UE 200 measures two neighbouring cells 232, 233 with measurements 301, 302, respectively. In the example, measurement 301 is done using the antenna panel 211 and the measurement 302 is done using antenna panel 212. The first antenna gain, e.g. a reported SCell value=2 for example, for cell 233, which may, for example, indicate that the value equals 6 dB in case of a quantisation step size of 3 dB. The reported SCell value (i.e. first antenna gain) for cell 232 could be for example 0. The SCell value=0 for cell 232 may reflect that the reported measurement for cell 232 is done on the same antenna panel 211 as already used by the serving cell 231, which means that if cell 232 is added along with the serving cell 231, the two cells 231, 232 would need to share the same antenna panel 211. Hence, potentially use a wide beam for simultaneous operation, and therefore no additional directivity gain can be obtained. The result in this example is that serving cell 231 may prefer adding cell 233 over cell 232 because of the additional gain that may be obtained with UE 200 narrow beam alignment. Hence the cell 231 may inform the UE 200 to add cell 233 as secondary cell.

FIG. 6 illustrates the message sequence procedure in example.
At stage 300, UE 200 measures the signal quality two neighbouring cell, in this example, cells 232, 233 with measurement 301, 302, respectively.
At stage 310, UE 200 determines 310 a beam for each cell 232, 233 that can be used for communication. This may happen as explained above in connection of stage 310 of FIG. 4.
At stage 320, UE 200 determines 320 the first obtainable antenna gain for non-serving cell 232 if a beam of antenna panel 211 is used for communication simultaneously on the serving cell 231 and on the non-serving cell 232 and the first obtainable antenna gain for the non-serving cell 233 if a beam of antenna panel 211 is used for communication with serving cell 231 and a beam of antenna panel 212 is used for communication with non-serving cell 233.
At stage 330, UE 200 transmits to serving cell 231 information 330 on the obtainable antenna gains. The information 330 may be reporting as SCell values for cell 232 and for 233, which may quantize for each cell the obtainable gain in a number of steps.
At stage 340, the serving cell 231 decides which one of the cells 232, 233, or both, or neither, to add as the secondary cell for the UE 200 in multi-carrier connectivity.

It is noted that in FIGS. 5 and 6, the UE may have measured the two neighbor cells 232 and 233 with nearly identical SSB RSRP values (e.g. −81 dBm for cell 233 and −80 dBm for cell 232). Per this RSRP measurement, cell 232 may be slightly better. But, as explained above, the reported first antenna gain is better for the cell 233 (e.g. index of two representing 6 dB, and index of 0 for cell 232 representing 0 dB gain). Based on this information, the network may in stage 340 prefer to add cell 233 as a secondary cell, even if cell 233 has a slightly lower RSRP than cell 232, since cell 233 can potentially achieve 6 dB higher antenna directivity.

According to various, but not necessarily all, embodiments there is provided an apparatus comprising means for determining a second antenna gain obtainable for the serving cell if the non-serving cell is added as a secondary cell in multicarrier connectivity with the serving cell, and transmitting to the base station information on said determined second antenna gain.

In the example of FIG. 5 and FIG. 6, UE may also report information on impact on obtainable antenna gain for the communication with current serving cell 231 (e.g. the second antenna gain) if non-serving cell 232 is added for multicarrier communication. This information may be reported as PCell value, which may quantize the impact on the antenna gain in a number of steps (e.g. see Table 1). That is, in case the UE wants to or needs to increase its beam width (lower the antenna gain) to cover both the current serving cell (PCell) and the possibly to be added secondary cell (SCell/PSCell), there may be an impact on the PCell, even though the UE may prioritize best directivity toward the PCell. Therefore, it may be beneficial to also inform the network about the impact on the PCell of adding an Scell. This is called the second antenna gain and it is obtainable for the serving cell. It is also known as PCell value or ACCI_PCell. In an example, in FIGS. 5 and 6, the UE may report an index value of 2 as the second antenna gain in case cell 233 is added as the secondary cell, and an index value of 0 as the second antenna gain in case cell 232 is added as the secondary cell.

The antenna gain obtainable is at least partially based on the array size of the antenna panel, e.g. 0-2 for a 1×4 array, 0-3 for a 1×8 array, etc. If the UE has panels with different array sizes, then the reported antenna gain values may be different. For example, if the UE has panel A with 1×2 array and panel B with 1×8 array, and two SCell candidates are detected (e.g. one with each panel), then even if narrow beam can be used for both of the cells, the panel with more array elements may provide a better gain. E.g. in FIG. 5, if antenna panel 211 for serving cell 231 was 1×2 array and antenna panel 212 for neighbor cell 233 was 1×8 array, then the reported ACCI_Scell and ACCI_PCell values with respect to possibly adding the neighbor cell 233 may be different, as better directivity may be obtained with panel 212 for the neighbor cell 233 (used for determining ACCI_SCell) than with panel 211 for the serving cell 231 (used for determining ACCI_PCell).

In an embodiment, the second antenna gain is not sent if the first and second antenna gains are the same. E.g. where the UE is able to or needs to create a common beam, which results in identical Scell (=ACCI_Scell=first antenna gain) and Pcell (=ACCI_PCell=second antenna gain) values, an optimization can be made for the reporting and the ACCI_PCell may be omitted meaning that the ACCI_SCell value is valid for both SCell and PCell (i.e. ACCI_Scell serves as both ACCI_SCell and ACCI_PCell).

According to various, but not necessarily all, embodiments there is provided an apparatus comprising means for determining a third antenna gain for the non-serving cell if the non-serving cell replaces the serving cell, and transmitting to the base station information on the third antenna gain.

In an embodiment, the UE may report to the network at least the first obtainable antenna gain (ACCI_Scell). In another embodiment, the UE reports to the network the first obtainable antenna gain (ACCI_Scell) and the second obtainable antenna gain (ACCI_PCell). In an embodiment, the UE reports to the network the first obtainable antenna gain (ACCI_Scell), the second obtainable antenna gain (ACCI_PCell), and the third obtainable antenna gain (ACCI). In an embodiment, the UE reports to the network the first obtainable antenna gain (ACCI_Scell), and the third obtainable antenna gain (ACCI). It may also be that a set of one or more antenna gains reported for a given neighbor cell is different from a set of one or more antenna gains reported for another neighbor cell. Table 2 lists the antenna gains.

TABLE 2
Antenna gains

| Gain type | Definition |
|---|---|
| ACCI_SCell | antenna gain for the neighbor cell if neighbor cell is added |
| | as SCell or PSCell and the serving cell is maintained. This |
| | is the first antenna gain. |
| ACCI_PCell | antenna gain for the serving cell if neighbor cell is added as |
| | SCell or PSCell and the serving cell is maintained. This is |
| | the second antenna gain. |
| ACCI | antenna gain for the neighbor cell, if the neighbor cell re- |
| | places the current serving cell. This is the third antenna |
| | gain. |

In an embodiment, the signal quality value(s) (e.g. one or more of RSRP, RSRQ, SINR) measured at the UE in stage 300 of FIG. 6 are reported to the gNB. This may take place in a MeasResultNR information element. This MeasResultNR information element may comprise an IE ResultsSSBCell comprising the signal quality value(s).

In an embodiment, the antenna gain(s) may be included in the MeasResultNR IE, possibly in the ResultsSSBCell IE.

According to various, but not necessarily all, embodiments there is provided an apparatus, wherein the information is useable in a procedure at the base station for adding the non-serving cell as a secondary cell in carrier aggregation. Referring to the example of FIG. 5, UE 200 measures two neighbouring cells 232, 233 with measurements 301, 302, respectively. In the example, measurement 301 is done using the antenna panel 211 and the measurement 302 is done using antenna panel 212. The reported SCell value=2 for example, for cell 233, which may, for example, indicate that the value equals 6 dB in case of a quantisation step size of 3 dB, and the reported SCell value for cell 232 could be for example 0. The SCell value=0 for cell 232 may reflect that the reported measurement for cell 232 is done on the same antenna panel 211 as used by the serving cell 231, which means that if cell 232 is added along with the serving cell 231, the two cells 231,232 would need to share the same antenna panel 211, hence, potentially use a wide beam for simultaneous operation, and therefore no additional directivity gain can be obtained. The network may in this example decide that if the antenna gain for the serving cell 231 would decrease below a threshold when the UE used the same shared beam 242 for communication with both cells. it may be preferable to add cell 233 instead of cell 232 because of the additional gain that may be obtained with UE 200 narrow beam 243 alignment. Hence the cell 231 informs the UE 200 to add cell 233 as secondary cell.

According to various, but not necessarily all, embodiments there is provided an apparatus, wherein the information is useable in a procedure at the base station for adding the non-serving cell as a secondary cell in dual connectivity aggregation. The procedure for this would be similar to that described above for adding the cell 233 as the secondary cell in carrier aggregation. However, in this case the cell 233 would be added for dual connectivity. In dual connectivity the second cell is from a different gNB (called secondary node, SN). The serving gNB which in dual connectivity is the master node, MN, may add the SN based on need for more throughput and received measurements. MN and SN communicate over X2/Xn (NR-LTE or NR-NR).

According to various, but not necessarily all, embodiments there is provided an apparatus, wherein the terminal device supports only one beam per antenna panel at a given time. This may be due to the UE RF architecture limitation that only utilize single-chain in the RF front-end (i.e. 1 set of phase shifters) per panel, therefore the UE can only use one beam per panel at a time.

According to various, but not necessarily all, embodiments there is provided comprising means for detecting a plurality of non-serving cells; determining, for each of the plurality of non-serving cells, a beam that is to be used for communication with the respective non-serving cell; determining, for each of the plurality of non-serving cells, the first antenna gain obtainable with the determined respective beam when the respective non-serving cell is added in multi-carrier connectivity with the serving cell; and informing the base station about the determined first antenna gain for at least one of the plurality of non-serving cells. This is shown in FIGS. 5 and 6, where the UE detects neighbor cells 232 and 233, and reports first antenna gains for both cells. In addition, the UE may report the second antenna gain(s) for the serving cell with respect to one or both of the neighbor cells 232 and 233.

According to various, but not necessarily all, embodiments there is provided an apparatus, wherein each antenna gain is dependent on width of the beam of the antenna panel used for determining the antenna gain.

According to various, but not necessarily all, embodiments there is provided an apparatus, wherein each antenna gain is indicated to the base station as an index value, wherein the index value maps to an antenna gain based on a predetermined mapping. Table 1 shows an example of index values and their mapping to antenna gains. The mapping may be preconfigured and known to both UE and network. The mapping may vary from that shown in Table 1. For example, the step size (3 dB in Table 1) and the granularity may vary. The information represented in Table 1 may be shared to the UE in system information (SIB), for example.

According to various, but not necessarily all, embodiments there is provided an apparatus, wherein the terminal device comprises at least two antenna panels, and further comprises means for determining which of the at least two antenna panels is to be used for communication with the non-serving cell. This may be based on e.g. performing the signal quality (e.g. RSRP) measurements with different antenna panels and selecting the antenna panel that provides the best signal quality results.

According to various, but not necessarily all, embodiments there is provided a network equipment (e.g. a gNB) comprising means for receiving information from a user equipment on at least one determined obtainable antenna gain corresponding to a non-serving cell if the non-serving cell is added as a secondary cell in multicarrier connectivity with a serving cell, and determining, based on the received information, whether to add said non-serving base station in the multicarrier connectivity for the user equipment.

The gNB may use the reported values of signal quality and antenna gain in the following way: if (“ΔACCI_PCell”<threshold and “RSRP+ACCI of NC”>threshold), then add NC, where ΔACCI is the impact on current antenna gain, RSPR is the measured signal quality, ACCI is the obtainable antenna gain (=first antenna gain), and NC is the neighboring cell measured.

The same example in numerical terms could be: if (“ΔACCI_PCell”<−1 (e.g −3 dB if step size is-3 dB) and “RSRP+ACCI of NC”>−80 dBm), then add NC.

For example, the network equipment may determine the optimum secondary cell selection when there are plural of Scell candidates (e.g. neighbor cells 232, 233) detected by the UE and the gNB receives the antenna gain value(s) for each of the Scell candidates.

According to various, but not necessarily all, embodiments there is provided a network equipment, wherein the received information comprises an indication of a first antenna gain obtainable for the non-serving cell by the user equipment if the non-serving cell is added as the secondary cell in multicarrier connectivity with the serving cell.

According to various, but not necessarily all, embodiments there is provided a network equipment, wherein the received information further comprises an indication of a second antenna gain obtainable for the serving cell by the user equipment if the nonserving cell is added as a secondary cell in multicarrier connectivity with the serving cell. The network equipment may evaluate based on the second antenna gain obtainable if it makes sense to add an SCell/PSCell given that the PCell antenna gain decreases.

According to various, but not necessarily all, embodiments there is provided a network equipment, wherein the received information further comprises an indication of a third antenna gain obtainable for the non-serving cell by the user equipment if the non-serving cell replaces the serving cell. The network may decide to do a handover from serving cell to the neighboring cell based on the third antenna gain report from the UE.

According to various, but not necessarily all, embodiments there is provided a network equipment comprising means for receiving information from the user equipment on at least one obtainable antenna gain corresponding to at least one further nonserving cell if the at least one non-serving cell is added as a secondary cell in multicarrier connectivity with the serving cell; determining, based on the received information, which one or more of the plurality of non-serving cells to add in multicarrier connectivity with the serving cell.

According to various, but not necessarily all, embodiments there is provided method (e.g. at a terminal device) comprising measuring signal quality of a non-serving cell, determining based on said signal quality a beam for said non-serving cell, determining a first antenna gain obtainable for the non-serving cell with said beam if the nonserving cell is added as a secondary cell in multicarrier connectivity with a serving cell, and transmitting to a base station of the serving cell information on said determined first antenna gain.

According to various, but not necessarily all, embodiments there is provided a computer program comprising instructions which, when the program is executed on an apparatus (e.g. computer/terminal device), cause the apparatus to carry out measuring signal quality of a non-serving cell, determining based on said signal quality a beam for said non-serving cell, determining a first antenna gain obtain-able for the non-serving cell with said beam if the non-serving cell is added as a secondary cell in multicarrier connectivity with a serving cell, and transmitting to a base station of the serving cell information on said determined first antenna gain.

According to various, but not necessarily all, embodiments there is provided method (e.g. at a network equipment) comprising receiving information from a user equipment on at least one obtainable antenna gain corresponding to a non-serving cell if the non-serving cell is added as a secondary cell in multicarrier connectivity with a serving cell, and determining, based on the received information, whether to add said nonserving base station in multicarrier connectivity for the user equipment.

According to various, but not necessarily all, embodiments there is provided a computer program comprising instructions which, when the program is executed on an apparatus (e.g. computer/network equipment), cause the apparatus to carry out receiving information from a user equipment on at least one obtainable antenna gain corresponding to a non-serving cell if the non-serving cell is added as a secondary cell in multicarrier connectivity with a serving cell, and determining, based on the received information, whether to add said non-serving base station in multicarrier connectivity for the user equipment.

UEs that reports obtainable antenna gain information allow the network to identify devices that have a more advanced control and configuration of the use of the antenna panels without exchange of beam index or additional protocols. Reporting the obtainable antenna gain of adding another cell for communication enables the network to determine the optimum secondary selection, e.g. in scenarios where the antenna beam is shared among non-collocated primary and secondary cells. Reporting the impact when using the same antenna panel for communication with both primary and secondary cells enable the network to evaluate the impact on antenna gain that may result from UE sharing the same antenna beam between secondary cell and primary cell.

The radio communication network may benefit of planning the secondary cell addition or handover based on the measurement reports from the UE. Also, knowing the impact of adding secondary cells allows the network to evaluate if it makes sense to add a secondary cell given that the primary cell antenna gain drops. The disclosure shows a way to inform gNB about potential UE beam gain without revealing specific UE implementation designs/secrets.

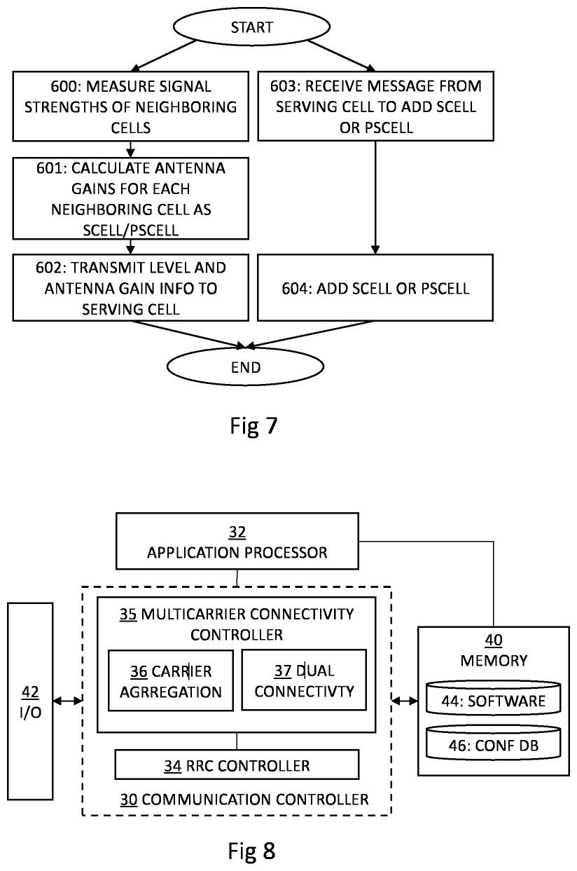

FIG. 7 illustrates an embodiment of a process for radio resource management in an apparatus (e.g. a terminal device). Referring to FIG. 7, the process carried out by the apparatus comprises: measuring (block 600) neighbouring cell signal strengths using the antennal panels of the apparatus; calculating (block 601) obtainable antenna gain for each measured cell if added as SCell or PSCell considering the antenna beam directivity, and determining the impact on PCell if an antenna panel would be used simultaneously for PCell and PSCell; and transmitting (block 602) information on each measure neighbouring's cell if added as SCell/PSCell and corresponding impact on PCell. Furthermore, the process carried out by the apparatus comprises: receiving (block 603) a message from serving cell to add a neighbouring cell as SCell or PSCell, and adding (block 604) a neighbouring cell as SCell or PSCell.

FIG. 8 illustrates an apparatus comprising a processing circuitry, such as at least one processor, and at least one memory 40 including a computer program code (software) 44, wherein the at least one memory and the computer program code (software) are configured, with the at least one processor, to cause the apparatus to carry out the process of FIG. 7 or any one of its embodiments described above for the terminal device. The apparatus may be or be for the terminal device. The apparatus may be a circuitry or an electronic device realizing some embodiments of the invention in the terminal device. The apparatus carrying out the above-described functionalities may thus be comprised in such a device, e.g. the apparatus may comprise a circuitry such as a chip, a chipset, a processor, a micro controller, or a combination of such circuitries for the terminal device. The processing circuitry may realize a communication controller 30 controlling communications with the access nodes 231, 232 to 233 of the cellular network infrastructures in the above-described manner. The communication controller may comprise a RRC controller 34 configured to establish and manage RRC connections and transfer of data over the RRC connections via the above-described multi-connectivity scenario.

The communication controller 30 may further comprise a multicarrier connectivity controller 35 configured to multicarrier connections of the terminal device. The multicarrier connectivity controller 35 may comprise a carrier aggregation controller 36 configured perform the above-described procedures for or during the carrier aggregation, for example. As another example, the multicarrier connectivity controller 35 may comprise a dual connectivity controller 37 configured perform the above-described procedures for or during the dual connectivity situation.

Referring to FIG. 8, the memory 40 may be implemented using any suitable data storage technology, such as semiconductor-based memory devices, flash memory, magnetic memory devices and systems, optical memory devices and systems, fixed memory and removable memory. The memory 40 may comprise a configuration database 46 for storing configuration parameters, e.g. the various handover parameters received in connection with the handover preparation such as the conditions for triggering the handover.

The apparatus may further comprise a communication interface 42 comprising hardware and/or software for providing the apparatus with radio communication capability with one or more access nodes, as described above. The communication interface 42. The communication interface 42 may comprise hardware and software needed for realizing the radio communications over the radio interface, e.g. according to specifications of an LTE or 5G radio interface.

The apparatus may further comprise an application processor 32 executing one or more computer program applications that generate a need to transmit and/or receive data through the communication controller 30. The application processor may form an application layer of the apparatus. The application processor may execute computer programs forming the primary function of the apparatus. For example, if the apparatus is a sensor device, the application processor may execute one or more signal processing applications processing measurement data acquired from one or more sensor heads. If the apparatus is a computer system of a vehicle, the application processor may execute a media application and/or an autonomous driving and navigation application. The application processor may generate data to be transmitted in the wireless network.

In another embodiment, apparatus of FIG. 8 may be or be for a network equipment, such as gNB. The apparatus may be a circuitry or an electronic device realizing some embodiments of the invention in the network equipment. The apparatus carrying out the above-described functionalities may thus be comprised in such a device, e.g. the apparatus may comprise a circuitry such as a chip, a chipset, a processor, a micro controller, or a combination of such circuitries for the network equipment. The processing circuitry may realize a communication controller 30 controlling communications with terminal device(s). The communication controller 30 may be responsible (in connection with the multicarrier connectivity controller 35) for adding, based on the received information, at least one neighbor cell in multicarrier connectivity for a terminal device. The communication controller may comprise a RRC controller 34 configured to establish and manage RRC connections and transfer of data over the RRC connections via the above-described multi-connectivity scenario.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention. The processes or methods described in connection with FIGS. 3 to 8 or any of the embodiments thereof may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include transitory and/or nontransitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Even though the embodiments have been described above with reference to examples according to the accompanying drawings, it is clear that the embodiments are not restricted thereto but can be modified in several ways within the scope of the appended claims. Therefore, all words and expressions should be interpreted broadly, and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1.-22. (canceled)

23. An apparatus comprising at least one processor and at least one memory storing instructions, wherein the at least one memory and the stored instructions are configured, with the at least one processor, to cause the apparatus to:
measure signal quality of a non-serving cell;
determine based on said signal quality a beam for said non-serving cell;
determine a first antenna gain obtainable for the non-serving cell with said beam if the non-serving cell is added as a secondary cell in multicarrier connectivity with a serving cell; and
transmit to a base station of the serving cell information on said determined first antenna gain.

24. The apparatus as claimed in claim 23, wherein the apparatus is further caused to determine the first antenna gain if a beam of a first antenna panel is used for communication simultaneously on the serving cell and on the non-serving cell.

25. The apparatus as claimed in claim 23, wherein the apparatus is further caused to determine the first antenna gain if a beam of a first antenna panel is used for communication on the serving cell and a beam of a second antenna panel is used for communication on the nonserving cell.

26. The apparatus as claimed in claim 23, wherein the apparatus is further caused to:
determine a second antenna gain obtainable for the serving cell if the non-serving cell is added as a secondary cell in multicarrier connectivity with the serving cell; and
transmit to the base station information on said determined second antenna gain.

27. The apparatus as claimed in claim 23, wherein the apparatus is further caused to:
determine a third antenna gain for the non-serving cell if the non-serving cell replaces the serving cell; and
transmit to the base station information on the third antenna gain.

28. The apparatus as claimed in claim 23, wherein the information is useable in a procedure at the base station for adding the non-serving cell as a secondary cell in carrier aggregation.

29. The apparatus as claimed in claim 23, wherein the information is useable in a procedure at the base station for adding the non-serving cell as a secondary cell in dual connectivity aggregation.

30. The apparatus as claimed in claim 23, wherein the apparatus supports only one beam per antenna panel.

31. The apparatus as claimed in claim 23, wherein the apparatus is further caused to:
detect a plurality of non-serving cells;
determine, for each of the plurality of non-serving cells, a beam that is to be used for communication with the respective non-serving cell;
determine, for each of the plurality of non-serving cells, at least the first antenna gain obtainable with the determined respective beam when the respective non-serving cell is added in multi-carrier connectivity with the serving cell; and
inform the base station about the determined first antenna gain for at least one of the plurality of non-serving cells.

32. The apparatus as claimed in claim 31, wherein each antenna gain is dependent on a width of the beam of the antenna panel used for determining the antenna gain.

33. The apparatus as claimed in claim 31, wherein each antenna gain is indicated to the base station as an index value, wherein the index value maps to an antenna gain based on a predetermined mapping.

34. The apparatus as claimed in claim 23, wherein the apparatus comprises at least two antenna panels, and wherein the apparatus is further caused to determine which of the at least two antenna panels is to be used for communication with the non-serving cell.

35. An apparatus, comprising at least one processor and at least one memory storing instructions, wherein the at least one memory and the stored instructions are configured, with the at least one processor, to cause the apparatus to:
receive information from a user equipment on at least one obtainable antenna gain corresponding to a non-serving cell if the non-serving cell is added as a secondary cell in multicarrier connectivity with a serving cell; and
determine, based on the received information, whether to add said non-serving base station in multicarrier connectivity for the user equipment.

36. The apparatus as claimed in claim 35, wherein the information comprises an indication of a first antenna gain obtainable for the non-serving cell by the user equipment if the non-serving cell is added as the secondary cell in multicarrier connectivity with the serving cell.

37. The apparatus as claimed in claim 36, wherein the information further comprises an indication of a second antenna gain obtainable for the serving cell by the user equipment if the non-serving cell is added as a secondary cell in multicarrier connectivity with the serving cell.

38. The apparatus as claimed in claim 37, wherein the information further comprises an indication of a third antenna gain obtainable for the non-serving cell by the user equipment if the non-serving cell replaces the serving cell.

39. The apparatus as claimed in claim 35, wherein the apparatus is further caused to:
receive information from the user equipment on at least one obtainable antenna gain corresponding to at least one further non-serving cell if the at least one non-serving cell is added as a secondary cell in multicarrier connectivity with the serving cell;
determine, based on the received information, which one or more of the plurality of nonserving cells to add in multicarrier connectivity with the serving cell.

40. A method performed by a user equipment, the method comprising:
measuring signal quality of a non-serving cell;
determining based on said signal quality a beam for said non-serving cell;
determining a first antenna gain obtainable for the non-serving cell with said beam if the non-serving cell is added as a secondary cell in multicarrier connectivity with a serving cell; and
transmitting to a base station of the serving cell information on said deter-mined antenna gain.

41. The method as claimed in claim 40, further comprising:
determining a second antenna gain obtainable for the serving cell if the non-serving cell is added as a secondary cell in multicarrier connectivity with the serving cell; and
transmitting to the base station information on said determined second antenna gain.

42. The method as claimed in claim 40, further comprising:
determining a third antenna gain for the non-serving cell if the non-serving cell replaces the serving cell; and
transmitting to the base station information on the third antenna gain.
